(19) United States
(12) Patent Application Publication
(10) Pub. No.: US 2003/0184418 A1
(43) Pub. Date: Oct. 2, 2003

(54) Structure of digital transmission line

(76) Inventor: Ta San Kao, Yun Lin Hsien (TW)

Correspondence Address: TROXELL LAW OFFICE PLLC, 5205 LEESBURG PIKE, SUITE 1404, FALLS CHRCH, VA, 22041, US

(21) Appl. No.: 10/106,504

(22) Filed: Mar. 27, 2002

(51) Int. Cl. H01P 3/06

(52) U.S. Cl. 333/243

(57) ABSTRACT

A structure of digital transmission line comprising a core material, a middle material layer and a coating layer, whereof, the core material is a transmission medium enveloped with an insulation PE foam layer; the coating layer includes at least one layer and is made of polyvinyl chloride; the middle material layer is provided between the core material and the coating layer, and is characterized by that the middle material layer is comprised of a copper foil wrapping layer, at least a metallic-wire knitting layer and a foamed Teflon-tape wrapping layer (PTFE). The middle material layer can get 100% obscuring, can minimize the degree of mutual interference, can maintain the characteristic impedance at 75Ω, and can get the result that no refraction or reflection of transmitted signals is induced during transmission.

### BACKGROUND OF THE INVENTION

1. Field of the Invention

The present invention is related to a structure of digital transmission line, and especially to such a structure having the characteristic impedance thereof maintained at 75Ω, when in transmission, no refraction or reflection of signal is induced; the digital transmission line particularly suits signal transmission.

2. Description of the Prior Art

Conventional structures of signal transmission lines, such as the coaxial cable structure shown in FIG. 1, are characterized in that: the insulation portion enveloping a conductor 1 is made a cylinder member 2 formed as a coaxial cable by press shaping of PE, and is combined with a Mylar tape 3 made from aluminum foil, an obscuring layer 4 made by knitting copper lines and a PVC enveloping member 5.

The coaxial cable is a round PE pipe made by press shaping, in order to lower its electric capacity and attenuation rate. However, the effect of insulation of PE is not the best, and the obscuring layer is not able to make 100% obscuring, and it is still a problem to be solved that it is not certain whether the characteristic impedance can be maintained under 75Ω, what will be the degree of mutual interference among a magnetic field, radio frequencies and static electricity, and whether refraction or reflection of transmitted signals is induced during transmission.

Thereby, it is the motive of the present invention to improve on the conventional structure of coaxial cables with the above stated defects, and to provide a structure of digital transmission line able to make 100% obscuring, to minimize the degree of mutual interference among a magnetic field, radio frequencies and stationary electricity, to maintain the characteristic impedance at 75Ω and to assure no refraction or reflection of transmitted signals is induced during transmission.

### SUMMARY OF THE INVENTION

The primary object of the present invention is to provide a structure of digital transmission line of which the characteristic impedance can be maintained at 75Ω.

The secondary object of the present invention is to provide a structure of digital transmission line with which the degree of mutual interference can be minimized, and 100% obscuring can be obtained.

Another object of the present invention is to provide a structure of digital transmission line with which no refraction or reflection of transmitted signals is induced during transmission.

To achieve the above stated objects, the present invention is comprised of a core material, a middle material layer and a coating layer; the core material is a transmission medium enveloped with an insulation PE foam layer; the coating layer includes at least one layer and is made of polyvinyl chloride; the middle material layer is provided between the core material and the coating layer, and is characterized by that the middle material layer is comprised of a copper foil wrapping layer, at least a metallic-wire knitting layer and a foamed Teflon-tape wrapping layer (PTFE). The middle material layer can get 100% obscuring, can minimize the degree of mutual interference, can maintain the characteristic impedance at 75Ω, and can get the result that no refraction or reflection of transmitted signals is induced during transmission.

The present invention will be apparent after reading the detailed description of the preferred embodiment thereof in reference to the accompanying drawings.

### BRIEF DESCRIPTION OF THE DRAWINGS

FIG. 1 is an analytical perspective view showing the structure of a conventional coaxial cable;

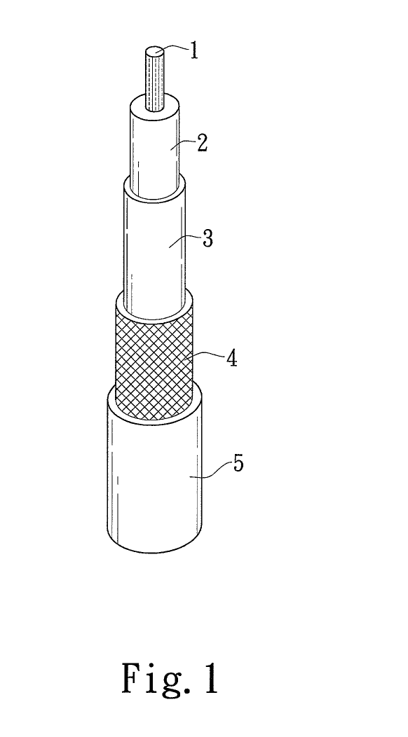

FIG. 2 is an analytical perspective view showing the structure of an embodiment of the present invention;

FIG. 3 shows a cross section of the embodiment of the present invention.

### DETAILED DESCRIPTION OF THE PREFERRED EMBODIMENT

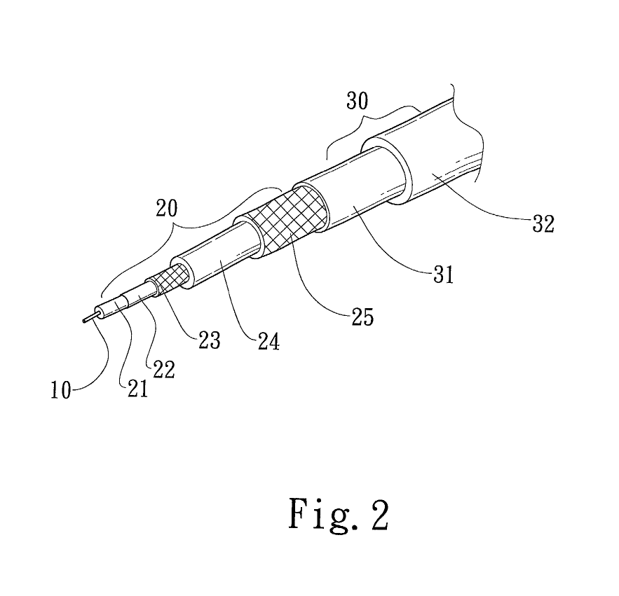

Referring firstly to FIG. 2, the present invention is comprised of a core material 10, a middle material layer 20 and a coating layer 30; wherein, the core material 10 is a transmission conductor made of pure silver with a large transmission speed; the middle material layer 20 is comprised of an insulation PE foam layer 21, a copper foil wrapping layer 22, a metallic-wire knitting layer 23, a foamed Teflon-tape (PTFE) wrapping layer 24 and another metallic-wire knitting layer 25. The metallic wires in the metallic-wire knitting layers 23, 25 are plated with silver. The coating layer 30 is comprised of a first coating layer 31 and a second coating layer 32 made of polyvinyl chloride (PVC).

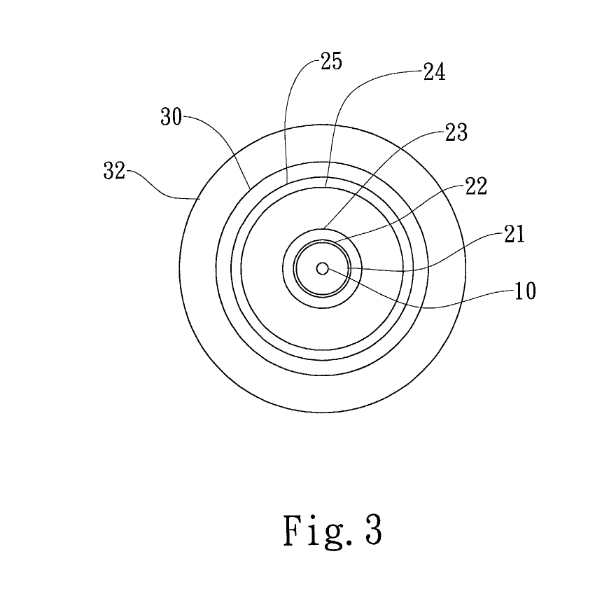

Referring to FIGS. 2 and 3, the core material 10 is in the first place enveloped with the PE foam layer 21, and then is enveloped with the copper foil wrapping layer 22, the metallic-wire knitting layer 23, the foamed Teflon-tape (PTFE) wrapping layer 24 and the metallic-wire knitting layer 25 sequentially of the middle material layer 20. Finally, it is enveloped on the outermost surface thereof with the first coating layer 31 and the second coating layer 32 of the coating layer 30 to complete the structure of the present invention.

By virtue that transmission speed of silver is the largest among the elements of the same class of it, and insulation of foamed PE materials is good, plus the summed obscuring ability of the copper foil wrapping layer and the two metallic-wire knitting layers can provide 100% obscuring, thereby, interference among a magnetic field, radio frequencies and static electricity can be effectively reduced; and more, the Teflon in the foamed Teflon-tape (PTFE) wrapping layer has a minimum insulation coefficient, its effect of insulation is the best, hence the degree of mutual interference can be minimize, and the characteristic impedance of the line can be maintained under 75Ω, thereby, attenuation rate can be reduced, distortion can be small, and quality of the line can be superior.

The structure of digital transmission line of the present invention can get a good effect of obscuring; it can avoid interference of a magnetic field, radio frequencies and static electricity. Therefore, it is novel and inventive in comparison with the electric wires available now. Having thus described the technical structure of my invention with industrial value, the structure has never existed in the markets, therefore, what I claim as new and desire to be secured by Letters Patent of the United States are:

1. A structure of digital transmission line comprising a core material, a middle material layer and a coating layer, said structure is characterized by that,
said core material is a transmission medium with a large transmission speed;
said coating layer includes at least a layer;
said middle material layer is provided between said core material and said coating layer, and is comprised of an insulation PE foam layer, a copper foil wrapping layer, at least a metallic-wire knitting layer and a foamed Teflon-tape wrapping layer.

2. The structure of digital transmission line as in claim 1, wherein,
said transmission medium with a large transmission speed is a conductor made of pure silver.

3. The structure of digital transmission line as in claim 1, wherein,
said at least a metallic-wire knitting layer of said middle material layer is plated with silver.

4. The structure of digital transmission line as in claim 1, wherein,
said coating layer including at least a layer is made of polyvinyl chloride (PVC).
